(19) United States
(12) Patent Application Publication
(10) Pub. No.: US 2003/0172036 A1
(43) Pub. Date: Sep. 11, 2003

(54) Online financial transaction veracity assurance mechanism

(76) Inventor: Idan Feigenbaum, Qiriyat Bialik (IL)

Correspondence Address: DANIEL J SWIRSKY, PO BOX 2345, BEIT SHEMESH, 99544, IL

(21) Appl. No.: 10/087,844

(22) Filed: Mar. 5, 2002

(51) Int. Cl. H04K 1/00; H04L 9/00; G06F 17/60

(52) U.S. Cl. 705/64

(57) ABSTRACT

A method for determining online financial transaction veracity, the method including determining a network address associated with an online payer in connection with an online payment instruction, determining an online payer location associated with the network address, receiving a payment instrument identification from the online payer, comparing the online payer location to a valid payment location profile associated with the payment instrument identification, and identifying the online payment instruction as a suspected fraudulent online payment attempt where the online payer location does not match the valid payment location profile.

### FIELD OF THE INVENTION

The present invention relates to electronic commerce in general, and more particularly to determining online financial transaction veracity.

### BACKGROUND OF THE INVENTION

In a typical “in-person” payment transaction, such as in connection with the purchase of goods or services, where a payment instrument other than money is used, such as a credit card, debit card, or check, the payer will present the instrument to the payee, such as a merchant, who, through various means, will attempt to verify that the payment instrument lawfully belongs to the payer and that the transaction is valid. Such means often include photo identification and automated verification systems into which payer identity information, such as the payer's name and address, are entered and verified against a database into which such information has been previously entered. By contrast, in electronic commerce transactions in which an online payer provides payment information to a payee by transmitting the data via a network, such as the Internet, photo identification is generally unavailable as a means for matching the payment instrument to the payer, and payer identity information is often insufficient to adequately verify that the online payer is actually the owner of the payment instrument. For example, an individual who is not the holder of a particular credit card might easily obtain both the name and the address of the actual credit card holder, and may fraudulently use the credit card in an online purchase and provide this information in order to gain authorization of the transaction.

Accordingly, what is needed is a system and method that overcomes the problems associated with typical verification methods for transactions involving a payment instrument, particularly electronic commerce transactions.

### SUMMARY OF THE INVENTION

The present invention discloses systems and methods for determining online financial transaction veracity that overcome disadvantages of the prior art.

In one aspect of the present invention there is provided a method for determining online financial transaction veracity, the method including a) determining a network address associated with an online payer in connection with an online payment instruction, b) determining an online payer location associated with the network address, c) receiving a payment instrument identification from the online payer, d) comparing the online payer location to a valid payment location profile associated with the payment instrument identification, and e) identifying the online payment instruction as a suspected fraudulent online payment attempt where the online payer location does not match the valid payment location profile.

In another aspect of the present invention the identifying step e) includes authorizing the online payment instruction as being valid where the online payer location matches the valid payment location profile.

In another aspect of the present invention the identifying step e) includes rejecting the online payment instruction where the online payer location does not match the valid payment location profile.

In another aspect of the present invention there is further included providing the suspected fraudulent online payment attempt to a payee to determine whether the payment attempt is fraudulent.

In another aspect of the present invention the determining step a) includes determining the network address of a communications device through which the online payer makes the online payment instruction.

In another aspect of the present invention the determining step a) includes determining an IP address of the communications device.

In another aspect of the present invention the determining step b) includes representing the online payer location as a geographical location.

In another aspect of the present invention the determining step b) includes representing the online payer location as a country.

In another aspect of the present invention the determining step b) includes representing the online payer location as a city.

In another aspect of the present invention the determining step b) includes representing the online payer location as an IP subnet address.

In another aspect of the present invention the receiving step c) includes receiving a credit card identification code.

In another aspect of the present invention the receiving step c) includes receiving a debit card identification code.

In another aspect of the present invention there is further included comparing the time at which the online payment instruction was made transaction takes place with the current time at either of the online payer location and a location indicated by the valid payment location profile, and identifying the online payment instruction as a suspected fraudulent online payment attempt where the times do not match.

In another aspect of the present invention there is further included determining the language of a browser used to send the online payment instruction, comparing the language with valid languages associated with the location of the online payer, and identifying the online payment instruction as a suspected fraudulent online payment attempt where the browser language does not match any of the valid languages.

In another aspect of the present invention there is further included storing on a computer used to send the online payment instruction an identification identifying either of the computer and the online payer and indicating the suspected fraudulent online payment attempt, retrieving the identification from the computer in conjunction with a subsequent online payment instruction, and identifying the subsequent online payment instruction as a subsequent suspected fraudulent online payment attempt where the identification retrieved from the computer indicates the first-mentioned suspected fraudulent online payment attempt.

In another aspect of the present invention there is further included storing on a computer used to send the online payment instruction an identification identifying either of the computer and the online payer, storing the identification and an indication of the suspected fraudulent online payment attempt in a database, retrieving the identification from the computer in conjunction with a subsequent online payment instruction, and identifying the subsequent online payment instruction as a subsequent suspected fraudulent online payment attempt where the identification retrieved from the computer matches the identification stored in the database.

In another aspect of the present invention there is provided a method for determining online financial transaction veracity, the method including comparing an element of an online payment instruction with a suspect payment instrucion profile, and identifying the online payment instruction as a suspected fraudulent online payment attempt where the element matches the suspect payment instrucion profile.

In another aspect of the present invention there is further included determining a network address associated with the online payer in connection with the online payment instruction, and where the element is at least a portion of the network address.

In another aspect of the present invention the element is an e-mail address of an online payer.

In another aspect of the present invention there is provided a system for determining online financial transaction veracity, the system including means for determining a network address associated with an online payer in connection with an online payment instruction, means for determining an online payer location associated with the network address, means for receiving a payment instrument identification from the online payer, means for comparing the online payer location to a valid payment location profile associated with the payment instrument identification, and means for identifying the online payment instruction as a suspected fraudulent online payment attempt where the online payer location does not match the valid payment location profile.

In another aspect of the present invention the identifying means is operative to authorize the online payment instruction as being valid where the online payer location matches the valid payment location profile.

In another aspect of the present invention the identifying means is operative to reject the online payment instruction where the online payer location does not match the valid payment location profile.

In another aspect of the present invention there is further included means for providing the suspected fraudulent online payment attempt to a payee to determine whether the payment attempt is fraudulent.

In another aspect of the present invention the means for determining a network address is operative to determine the network address of a communications device through which the online payer makes the online payment instruction.

In another aspect of the present invention the means for determining a network address is operative to determine an IP address of the communications device.

In another aspect of the present invention the means for determining an online payer location is operative to represent the online payer location as a geographical location.

In another aspect of the present invention the means for determining an online payer location is operative to represent the online payer location as a country.

In another aspect of the present invention the means for determining an online payer location is operative to represent the online payer location as a city.

In another aspect of the present invention the means for determining an online payer location is operative to represent the online payer location as an IP subnet address.

In another aspect of the present invention the means for receiving is operative to receive a credit card identification code.

In another aspect of the present invention the means for receiving is operative to receive a debit card identification code.

In another aspect of the present invention there is further included means for comparing the time at which the online payment instruction was made transaction takes place with the current time at either of the online payer location and a location indicated by the valid payment location profile, and means for identifying the online payment instruction as a suspected fraudulent online payment attempt where the times do not match.

In another aspect of the present invention there is further included means for determining the language of a browser used to send the online payment instruction, means for comparing the language with valid languages associated with the location of the online payer, and means for identifying the online payment instruction as a suspected fraudulent online payment attempt where the browser language does not match any of the valid languages.

In another aspect of the present invention there is further included means for storing on a computer used to send the online payment instruction an identification identifying either of the computer and the online payer and indicating the suspected fraudulent online payment attempt, means for retrieving the identification from the computer in conjunction with a subsequent online payment instruction, and means for identifying the subsequent online payment instruction as a suspected subsequent fraudulent online payment attempt where the identification retrieved from the computer indicates the first-mentioned suspected fraudulent online payment attempt.

In another aspect of the present invention there is further included means for storing on a computer used to send the online payment instruction an identification identifying either of the computer and the online payer, means for storing the identification and an indication of the suspected fraudulent online payment attempt in a database, means for retrieving the identification from the computer in conjunction with a subsequent online payment instruction, and means for identifying the subsequent online payment instruction as a suspected subsequent fraudulent online payment attempt where the identification retrieved from the computer matches the identification stored in the database.

In another aspect of the present invention there is provided a system for determining online financial transaction veracity, the system including means for comparing an element of an online payment instruction with a suspect payment instruction profile, and means for identifying the online payment instruction as a suspected fraudulent online payment attempt where the element matches the suspect payment instruction profile.

In another aspect of the present invention there is further included means for determining a network address associated with the online payer in connection with the online payment instruction, and where the element is at least a portion of the network address.

In another aspect of the present invention the element is an e-mail address of an online payer.

The disclosures of all patents, patent applications, and other publications mentioned in this specification and of the patents, patent applications, and other publications cited therein are hereby incorporated by reference in their entirety.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a system for determining online financial transaction veracity, constructed and operative in accordance with a preferred embodiment of the present invention;

FIG. 2 is a simplified flowchart illustration of an exemplary method of operation of the system of FIG. 1, operative in accordance with a preferred embodiment of the present invention;

FIG. 3 is a simplified conceptual illustration of a system for determining online financial transaction veracity, constructed and operative in accordance with a preferred embodiment of the present invention;

FIG. 4 is a simplified flowchart illustration of an exemplary method of operation of the system of FIG. 3, operative in accordance with a preferred embodiment of the present invention;

FIG. 5 is a simplified conceptual illustration of a system for determining online financial transaction veracity, constructed and operative in accordance with a preferred embodiment of the present invention;

FIG. 6 is a simplified flowchart illustration of an exemplary method of operation of the system of FIG. 5, operative in accordance with a preferred embodiment of the present invention;

FIG. 7 is a simplified flowchart illustration of an exemplary method of determining online financial transaction veracity, operative in accordance with a preferred embodiment of the present invention;

FIG. 8 is a simplified flowchart illustration of an exemplary method of determining online financial transaction veracity, operative in accordance with a preferred embodiment of the present invention; and

FIG. 9 is a simplified flowchart illustration of an exemplary method of determining online financial transaction veracity, operative in accordance with a preferred embodiment of the present invention.

### DETAILED DESCRIPTION OF PREFERRED EMBODIMENTS

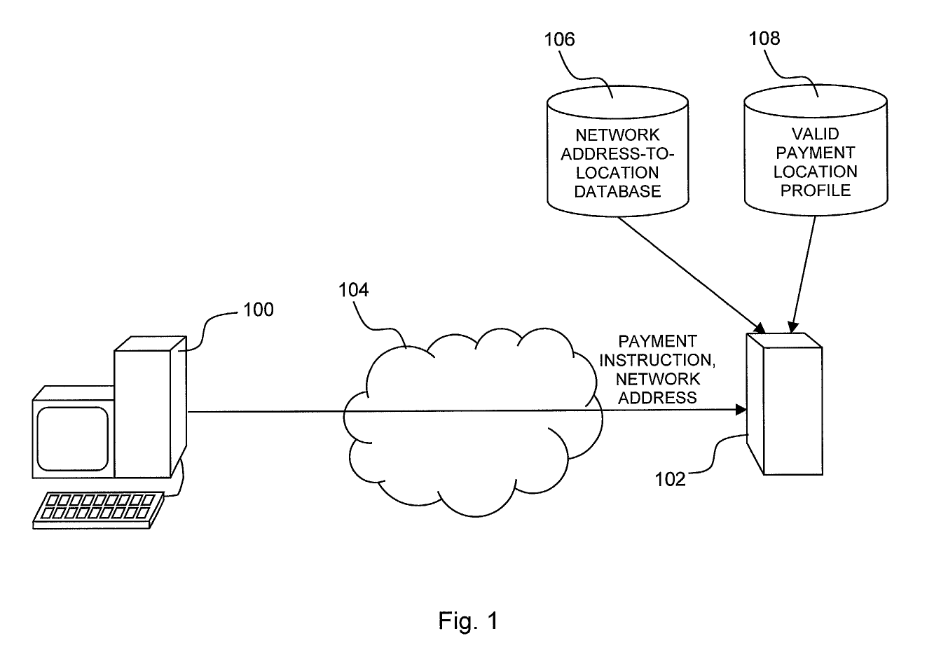

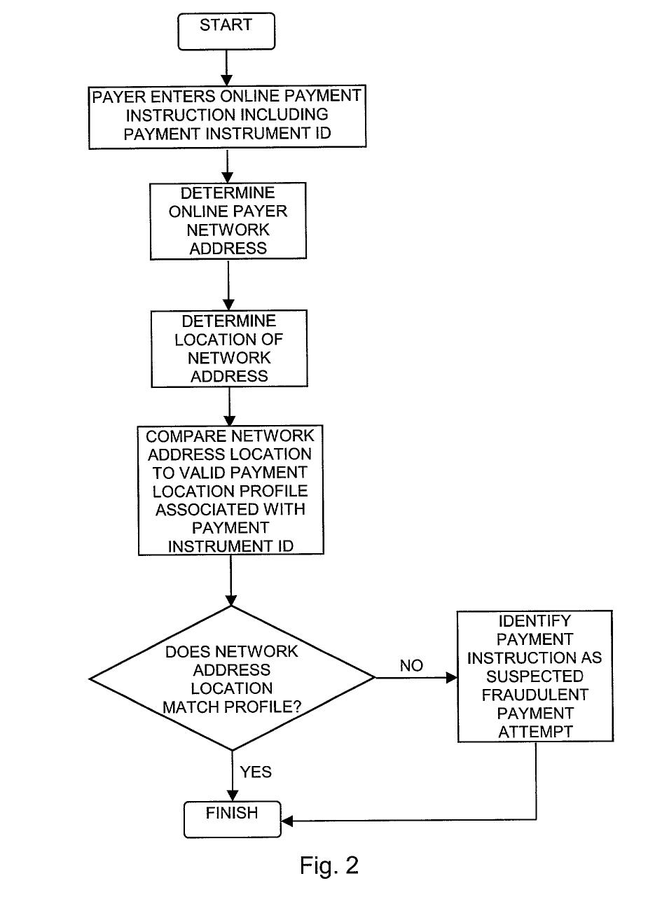

Reference is now made to FIG. 1, which is a simplified conceptual illustration of a system for determining online financial transaction veracity, constructed and operative in accordance with a preferred embodiment of the present invention, and additionally to FIG. 2, which is a simplified flowchart illustration of an exemplary method of operation of the system of FIG. 1, operative in accordance with a preferred embodiment of the present invention. In the system of FIG. 1 and method of FIG. 2 a payer (not shown) enters an online payment instruction, such as in connection with the online purchase of goods or services, at a communications device, such as a computer 100, and transmits the payment instruction to a computer 102, typically being a network server, via a network 104, such as the Internet. The payer, also referred to as the online payer, typically provides payment information as part of the payment instruction. This payment information typically includes an identification, such as a number, code, or other identifier, of a payment instrument, such as, but not limited to, a credit card, debit card, smart card, bank account, or an electronic wallet. Other information may also be provided by the payer as part of the payment instruction, with or without the payer's intervention, such as a request for goods or services, or identity information, typically of the payer, such as name, postal address, email address, and shipping address.

Upon receiving the payment instruction, computer 102 determines a network address associated with the online payer using conventional techniques. Typically, the network address is of the communications device used to transmit the payment instruction, such as computer 100, and is transmitted as part of the payment instruction without the payer's intervention. The network address may be an IP network address, such as where network 104 is the Internet, or any other type of address. Computer 102 then determines a location associated with the network address using conventional methods, such as by employing a network address-to-location database 106 in which network addresses are mapped to locations. The location is used to represent the location of the online payer, and may be a geographical location, such as a country or city, or a non-geographical location, such as the logical location represented by an IP subnet address.

Once the online payer location has been determined, computer 102 compares the online payer location to a valid payment location profile 108 associated with the payment instrument identification. For example, valid payment location profile 108 may include locations from which use of the payment instrument is considered to be valid, such as the location from which the payment instrument was issued to the payer, a location currently listed as the postal address associated with the payment instrument, and/or locations in which the payer previously used the payment instrument to make purchases. The online payment instruction may then be identified by computer 102 as a suspected fraudulent online payment attempt where the online payer location does not match the valid payment location profile, or as a valid online payment attempt. Suspected fraudulent online payment attempts may then be provided for review by the payee to determine whether the payment attempt is indeed fraudulent. Alternatively, the online payment instruction may be automatically authorized as a valid online payment attempt where the online payer location matches the valid payment location profile, and rejected where the online payer location does not match the valid payment location profile.

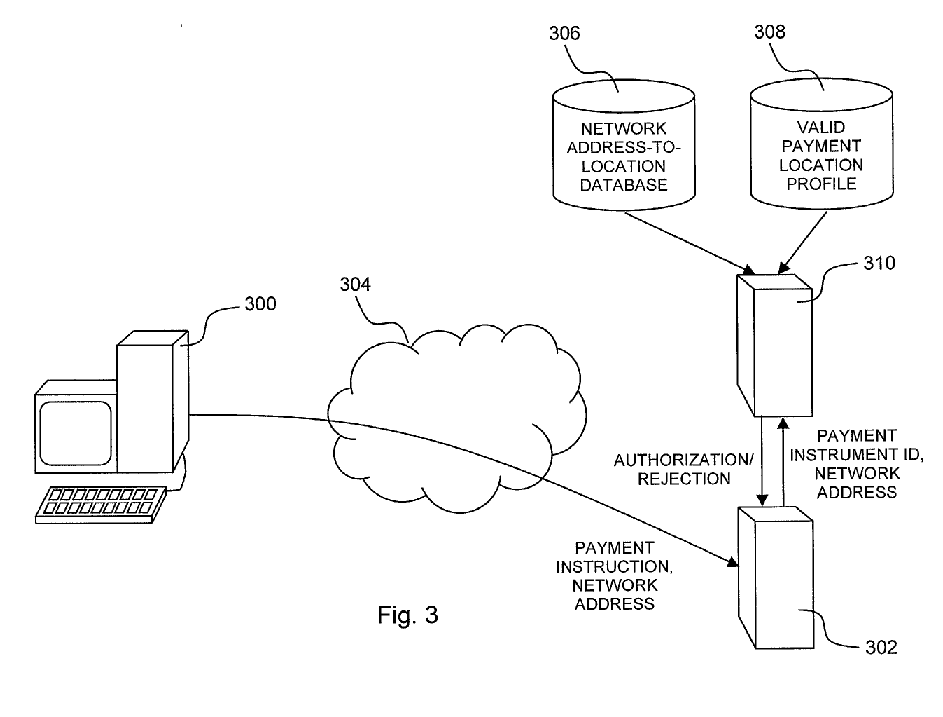

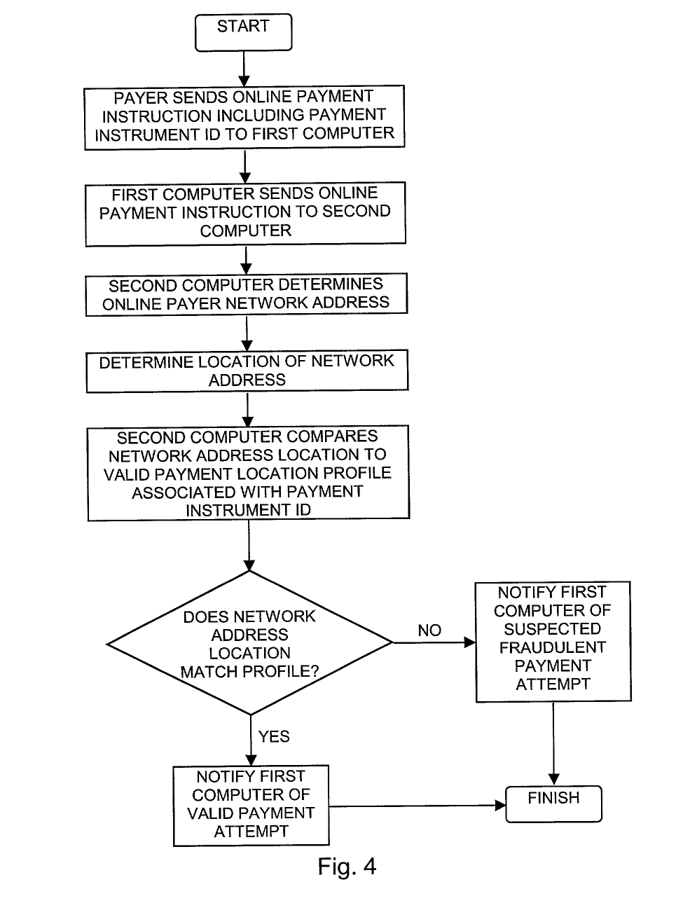

Reference is now made to FIG. 3, which is a simplified conceptual illustration of a system for determining online financial transaction veracity, constructed and operative in accordance with a preferred embodiment of the present invention, and additionally to FIG. 4, which is a simplified flowchart illustration of an exemplary method of operation of the system of FIG. 3, operative in accordance with a preferred embodiment of the present invention. The system of FIG. 3 and method of FIG. 4 are substantially similar to the system of FIG. 1 and method of FIG. 2 except as is now noted. In the system of FIG. 3 and method of FIG. 4 the payer (not shown) enters an online payment instruction at a computer 300 and transmits the payment instruction to a computer 302 via a network 304, such as the Internet. The payer typically provides payment information as part of the payment instruction, including an identification of a payment instrument.

Upon receiving the payment instruction, computer 302 determines a network address associated with the online payer. Computer 302 then transmits the network address and the payment instrument identification to a computer 310, typically being a network server, via network 304 or using other communications means. Computer 310 then determines a location associated with the network address using conventional methods, such as by employing a network address-to-location database 306 in which network addresses are mapped to locations. The location is used to represent the location of the online payer, and may be a geographical location, such as a country or city, or a non-geographical location, such as the logical location represented by an IP subnet address.

Once the online payer location has been determined, computer 310 compares the online payer location to a valid payment location profile 308 associated with the payment instrument identification and which includes valid locations. The online payment instruction may then be identified by computer 310 as a suspected fraudulent online payment attempt where the online payer location does not match the valid payment location profile, or as a valid online payment attempt. Computer 310 may then transmit an authorization or a rejection to computer 302, upon which computer 302 may accept or reject the payment attempt.

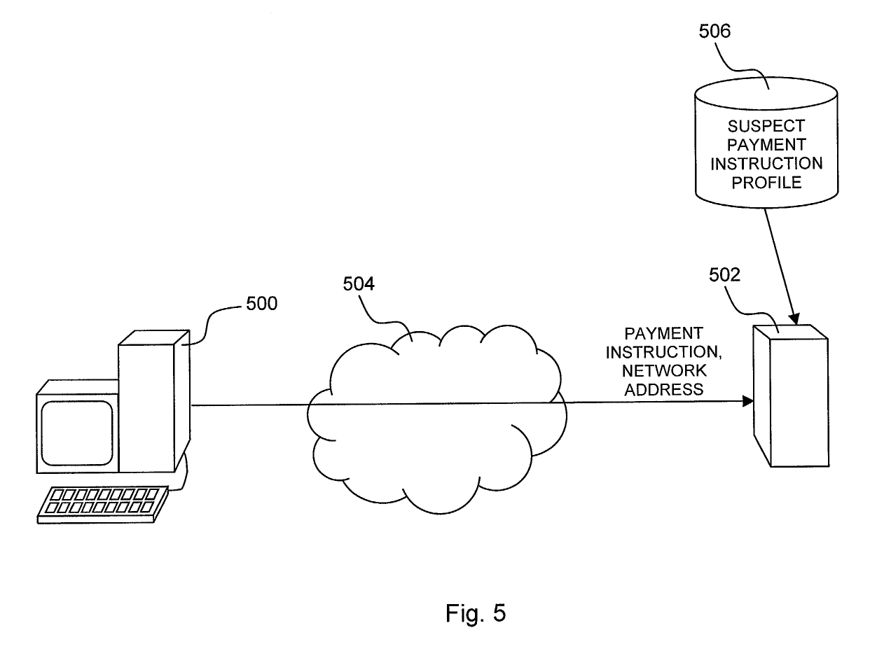

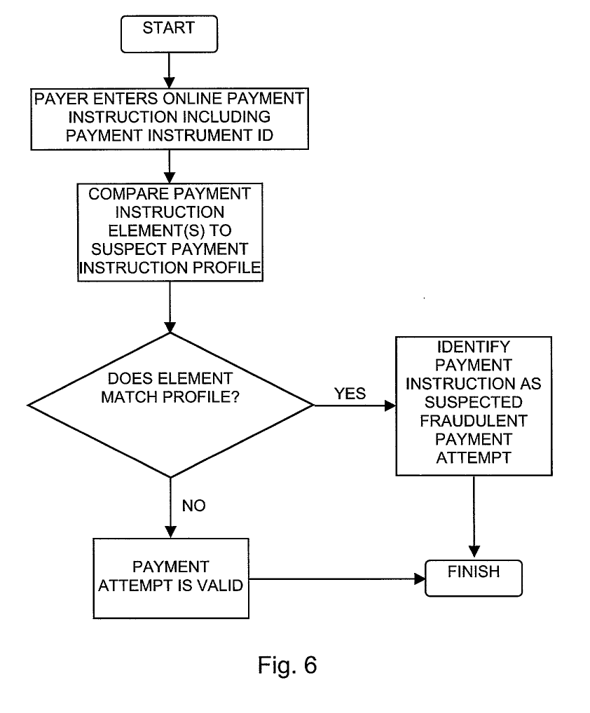

Reference is now made to FIG. 5, which is a simplified conceptual illustration of a system for determining online financial transaction veracity, constructed and operative in accordance with a preferred embodiment of the present invention, and additionally to FIG. 6, which is a simplified flowchart illustration of an exemplary method of operation of the system of FIG. 5, operative in accordance with a preferred embodiment of the present invention. The system of FIG. 5 and method of FIG. 6 are substantially similar to the system of FIG. 1 and method of FIG. 2 except as is now noted. In the system of FIG. 5 and method of FIG. 6 the payer (not shown) enters an online payment instruction at a computer 500 and transmits the payment instruction to a computer 502 via a network 504, such as the Internet. The payer typically provides payment information as part of the payment instruction, including an identification of a payment instrument.

Upon receiving the payment instruction, computer 502 compares one or more elements of the payment instruction, such as the network address or a portion thereof (such as an IP subnet portion of an IP address), identity information, email address, etc., to a suspect payment instruction profile 506 which includes corresponding elements known to be associated with fraudulent transactions or with mechanisms for hiding the actual location of the payer. Suspect payment instruction profile 506 may be constructed using information from previous fraudulent transactions such as may be determined using any of the methods described herein. The online payment instruction may then be identified by computer 502 as a suspected fraudulent online payment attempt where the element being checked matches suspect payment instruction profile 506, or as a valid online payment attempt. The payee or computer 502 may then accept or reject the payment attempt.

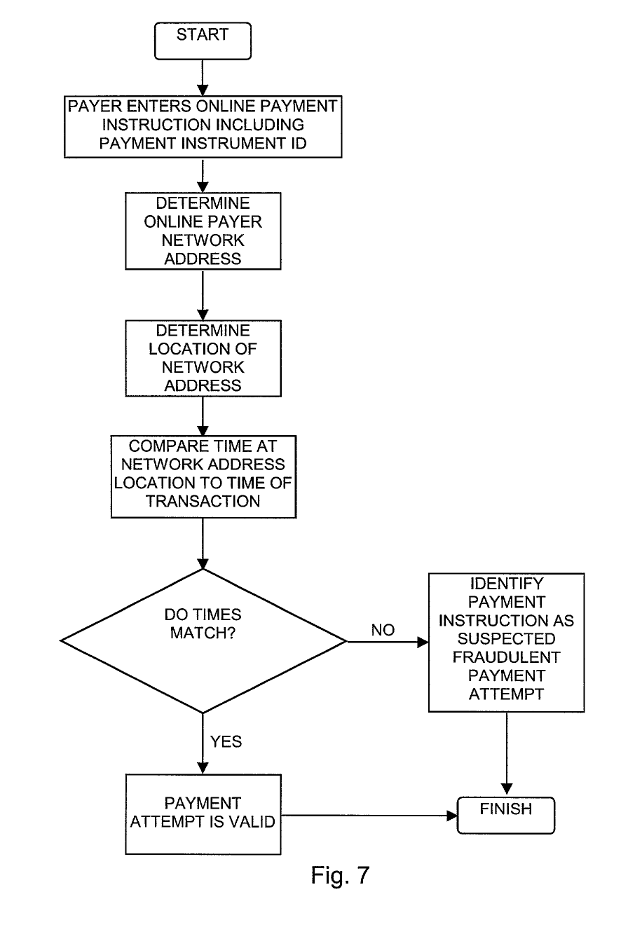

Reference is now made to FIG. 7, which is a simplified flowchart illustration of an exemplary method of determining online financial transaction veracity, operative in accordance with a preferred embodiment of the present invention. The method of FIG. 7 may be applied in conjunction with any of the methods described herein. In the method of FIG. 7, the time at which the transaction attempt takes place is compared with the current time at the payment instrument location and/or network address location of the online payer, determined as described hereinabove. The transaction may then be identified as a suspected fraudulent transaction attempt if the time of the transaction does not match the current time at the location of the online payer.

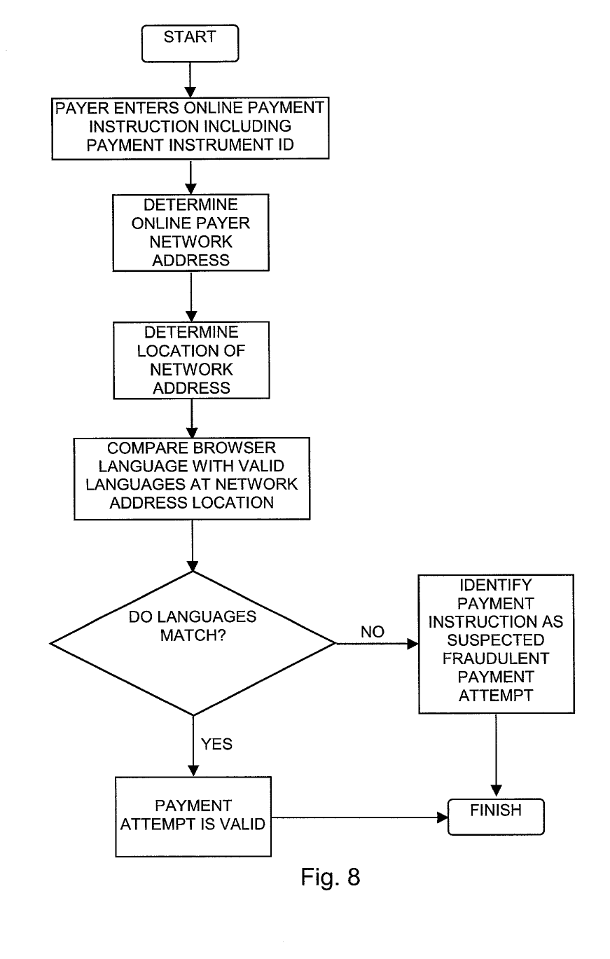

Reference is now made to FIG. 8, which is a simplified flowchart illustration of an exemplary method of determining online financial transaction veracity, operative in accordance with a preferred embodiment of the present invention. The method of FIG. 8 may be applied in conjunction with any of the methods described herein. In the method of FIG. 8, the language of the user's browser is determined using conventional techniques. The language is then compared with a list of languages used in or otherwise valid for the payment instrument location and/or network address location of the online payer, determined as described hereinabove. The transaction may then be identified as a suspected fraudulent transaction attempt if the language is not consistent with valid languages associated with the location of the online payer.

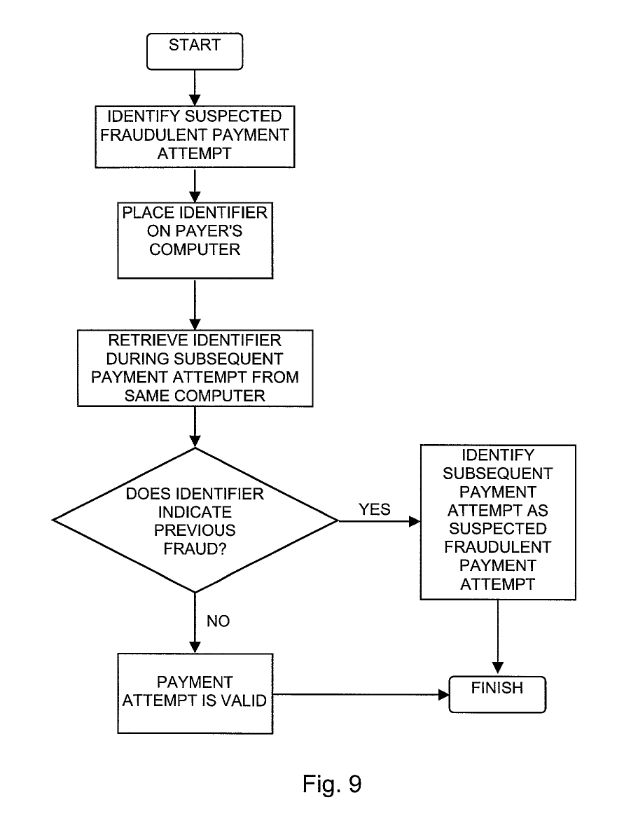

Reference is now made to FIG. 9, which is a simplified flowchart illustration of an exemplary method of determining online financial transaction veracity, operative in accordance with a preferred embodiment of the present invention. The method of FIG. 9 may be applied in conjunction with any of the methods described herein. In the method of FIG. 9, once a suspected fraudulent transaction attempt has been identified as having been transmitted by a particular computer, an identifier, such as a cookie or other known marker used to identify the computer and/or the computer user, may be stored on the computer using conventional techniques. The identifier preferably includes an indication that a fraudulent transaction attempt was detected. Alternatively, the identifier does not include such an indication, but rather the identifier is also stored on a database that is not accessible to the computer user together with an indication that the identifier is associated with a fraudulent transaction attempt. Subsequent transaction requests by the same computer or computer user, as identified by retrieving the identifier, may then be automatically identified as a suspected fraudulent transaction attempt.

It is appreciated that one or more of the steps of any of the methods described herein may be omitted or carried out in a different order than that shown, without departing from the true spirit and scope of the invention.

While the methods and apparatus disclosed herein may or may not have been described with reference to specific hardware or software, it is appreciated that the methods and apparatus described herein may be readily implemented in hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention. For example, the present invention may be adapted for use with financial transactions other than payment transactions.

What is claimed is:

1. A method for determining online financial transaction veracity, the method comprising:
a) determining a network address associated with an online payer in connection with an online payment instruction;
b) determining an online payer location associated with said network address;
c) receiving a payment instrument identification from said online payer;
d) comparing said online payer location to a valid payment location profile associated with said payment instrument identification; and
e) identifying said online payment instruction as a suspected fraudulent online payment attempt where said online payer location does not match said valid payment location profile.

2. A method according to claim 1 wherein said identifying step e) comprises authorizing said online payment instruction as being valid where said online payer location matches said valid payment location profile.

3. A method according to claim 1 wherein said identifying step e) comprises rejecting said online payment instruction where said online payer location does not match said valid payment location profile.

4. A method according to claim 1 and further comprising providing said suspected fraudulent online payment attempt to a payee to determine whether said payment attempt is fraudulent.

5. A method according to claim 1 wherein said determining step a) comprises determining said network address of a communications device through which said online payer makes said online payment instruction.

6. A method according to claim 5 wherein said determining step a) comprises determining an IP address of said communications device.

7. A method according to claim 1 wherein said determining step b) comprises representing said online payer location as a geographical location.

8. A method according to claim 7 wherein said determining step b) comprises representing said online payer location as a country.

9. A method according to claim 7 wherein said determining step b) comprises representing said online payer location as a city.

10. A method according to claim 6 wherein said determining step b) comprises representing said online payer location as an IP subnet address.

11. A method according to claim 1 wherein said receiving step c) comprises receiving a credit card identification code.

12. A method according to claim 1 wherein said receiving step c) comprises receiving a debit card identification code.

13. A method according to claim 1 and further comprising:
comparing the time at which said online payment instruction was made transaction takes place with the current time at either of said online payer location and a location indicated by said valid payment location profile; and
identifying said online payment instruction as a suspected fraudulent online payment attempt where said times do not match.

14. A method according to claim 1 and further comprising:
determining the language of a browser used to send said online payment instruction;
comparing said language with valid languages associated with the location of said online payer; and
identifying said online payment instruction as a suspected fraudulent online payment attempt where said browser language does not match any of said valid languages.

15. A method according to claim 1 and further comprising:
storing on a computer used to send said online payment instruction an identification identifying either of said computer and said online payer and indicating said suspected fraudulent online payment attempt;
retrieving said identification from said computer in conjunction with a subsequent online payment instruction; and
identifying said subsequent online payment instruction as a subsequent suspected fraudulent online payment attempt where said identification retrieved from said computer indicates said first-mentioned suspected fraudulent online payment attempt.

16. A method according to claim 1 and further comprising:
storing on a computer used to send said online payment instruction an identification identifying either of said computer and said online payer;
storing said identification and an indication of said suspected fraudulent online payment attempt in a database;
retrieving said identification from said computer in conjunction with a subsequent online payment instruction; and
identifying said subsequent online payment instruction as a subsequent suspected fraudulent online payment attempt where said identification retrieved from said computer matches said identification stored in said database.

17. A method for determining online financial transaction veracity, the method comprising:
comparing an element of an online payment instruction with a suspect payment instrucion profile; and
identifying said online payment instruction as a suspected fraudulent online payment attempt where said element matches said suspect payment instrucion profile.

18. A method according to claim 17 and further comprising:
determining a network address associated with said online payer in connection with said online payment instruction, and wherein said element is at least a portion of said network address.

19. A method according to claim 17 wherein said element is an e-mail address of an online payer.

20. A system for determining online financial transaction veracity, the system comprising:
means for determining a network address associated with an online payer in connection with an online payment instruction;
means for determining an online payer location associated with said network address;
means for receiving a payment instrument identification from said online payer;
means for comparing said online payer location to a valid payment location profile associated with said payment instrument identification; and
means for identifying said online payment instruction as a suspected fraudulent online payment attempt where said online payer location does not match said valid payment location profile.

21. A system according to claim 20 wherein said identifying means is operative to authorize said online payment instruction as being valid where said online payer location matches said valid payment location profile.

22. A system according to claim 20 wherein said identifying means is operative to reject said online payment instruction where said online payer location does not match said valid payment location profile.

23. A system according to claim 20 and further comprising means for providing said suspected fraudulent online payment attempt to a payee to determine whether said payment attempt is fraudulent.

24. A system according to claim 20 wherein said means for determining a network address is operative to determine said network address of a communications device through which said online payer makes said online payment instruction.

25. A system according to claim 24 wherein said means for determining a network address is operative to determine an IP address of said communications device.

26. A system according to claim 20 wherein said means for determining an online payer location is operative to represent said online payer location as a geographical location.

27. A system according to claim 26 wherein said means for determining an online payer location is operative to represent said online payer location as a country.

28. A system according to claim 26 wherein said means for determining an online payer location is operative to represent said online payer location as a city.

29. A system according to claim 25 wherein said means for determining an online payer location is operative to represent said online payer location as an IP subnet address.

30. A system according to claim 20 wherein said means for receiving is operative to receive a credit card identification code.

31. A system according to claim 20 wherein said means for receiving is operative to receive a debit card identification code.

32. A system according to claim 20 and further comprising:
means for comparing the time at which said online payment instruction was made transaction takes place with the current time at either of said online payer location and a location indicated by said valid payment location profile; and
means for identifying said online payment instruction as a suspected fraudulent online payment attempt where said times do not match.

33. A system according to claim 20 and further comprising:
means for determining the language of a browser used to send said online payment instruction;
means for comparing said language with valid languages associated with the location of said online payer; and
means for identifying said online payment instruction as a suspected fraudulent online payment attempt where said browser language does not match any of said valid languages.

34. A system according to claim 20 and further comprising:
means for storing on a computer used to send said online payment instruction an identification identifying either of said computer and said online payer and indicating said suspected fraudulent online payment attempt;
means for retrieving said identification from said computer in conjunction with a subsequent online payment instruction; and
means for identifying said subsequent online payment instruction as a suspected subsequent fraudulent online payment attempt where said identification retrieved from said computer indicates said first-mentioned suspected fraudulent online payment attempt.

35. A system according to claim 20 and further comprising:
means for storing on a computer used to send said online payment instruction an identification identifying either of said computer and said online payer;
means for storing said identification and an indication of said suspected fraudulent online payment attempt in a database;
means for retrieving said identification from said computer in conjunction with a subsequent online payment instruction; and
means for identifying said subsequent online payment instruction as a suspected subsequent fraudulent online payment attempt where said identification retrieved from said computer matches said identification stored in said database.

36. A system for determining online financial transaction veracity, the system comprising:
means for comparing an element of an online payment instruction with a suspect payment instrucion profile; and
means for identifying said online payment instruction as a suspected fraudulent online payment attempt where said element matches said suspect payment instrucion profile.

37. A system according to claim 36 and further comprising:
means for determining a network address associated with said online payer in connection with said online payment instruction, and wherein said element is at least a portion of said network address.

38. A system according to claim 36 wherein said element is an e-mail address of an online payer.
